(19) United States
(12) Patent Application Publication
(10) Pub. No.: US 2012/0201036 A1
(43) Pub. Date: Aug. 9, 2012

(54) HEAT SINK WITH INTERNAL CHANNELS

(76) Inventor: Takeho HSU, Taipei City (TW)

(21) Appl. No.: 13/423,326

(22) Filed: Mar. 19, 2012

(30) Foreign Application Priority Data
Feb. 8, 2011 (TW) 100214233

(51) Int. Cl. F21V 29/00; F28F 7/00

(52) U.S. Cl. 362/373; 165/185

(57) ABSTRACT

A heat sink includes a base and a polygonal heat dissipating module disposed on and integrally formed with the base. Furthermore, heat dissipating channels penetrate through the polygonal heat dissipating module and are arranged in different directions. Thus, the heat on the base can be conducted to the polygonal heat dissipating module, and the flowing air streams can quickly bring out the heat through the corresponding heat dissipating channels so that the heat dissipation efficiency can be enhanced

### BACKGROUND OF THE INVENTION

1. Field of the Invention

The invention relates to the technical field of a heat sink, and more particularly to a heat sink with internal channels, wherein the heat sink can be applied to a light-emitting diode (LED) road lamp, a solar energy/thermoelectric conversion apparatus, or an apparatus or an element for dissipating heat by way of heat transfer.

2. Related Art

A typical opto-electronic apparatus, such as a LED apparatus, generates a lot of heat in the working process, and the heat decreases the working efficiency and the lifetime of the opto-electronic apparatus. Therefore, the opto-electronic apparatus works in conjunction with a heat sink or a heat dissipating system for dissipating the heat.

A frequently seen heat sink mounted outdoors has parallel contour heat dissipating fins for absorbing the heat. Then, the surface of each heat dissipating fin dissipates the heat to the atmosphere by way of radiation. Because the heat sink is exposed to the atmosphere, the heat sink may contact with the rain, dust or leaves and is not adapted to the condition with a fan. In order to enhance the heat dissipating effect, the surface area of the heat sink has to be enlarged.

The way of enlarging the heat dissipating area is to increase the number of the heat dissipating fins, but this way decreases the gap between the heat dissipating fins. Because the heat dissipating fins have the parallel and contour structures, the heat of the inner heat dissipating fins cannot be easily dissipated and is thus accumulated. So, the heat dissipating effect cannot be substantially enhanced. Next, the too dense heat dissipating fins tend to increase the possibility of accumulating the dust or leaves, so that the heat dissipating effect is deteriorated.

In addition, the flowing air streams can contact with the heat sink and thus enhance the heat dissipating effect. However, if the windward side of the heat sink is just the surface of the heat dissipating fin, the flowing air streams cannot easily enter the inner layer of the heat sink. So, the heat dissipating effect is not ideal.

### SUMMARY OF THE INVENTION

It is therefore an object of the invention to provide a heat sink with internal channels, wherein the flowing air streams can enter the heat sink to enhance the heat dissipating effect of the heat sink.

Another object of the invention is to provide a heat sink with internal heat dissipating channels arranged in different directions so that air streams flowing in various directions can pass through the corresponding heat dissipating channels to enhance the heat dissipating effect.

According to the above-identified objects and effects, the invention discloses a heat sink including a base, a polygonal heat dissipating module and heat dissipating channels. The polygonal heat dissipating module is disposed on and integrally formed with the base. The heat dissipating channels penetrate through the polygonal heat dissipating module and are arranged in different directions. Thus, the heat on the base can be conducted to the polygonal heat dissipating module, and the air streams can flow through the corresponding heat dissipating channels and thus quickly bring out the heat, so that the heat dissipation efficiency is enhanced.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a pictorial view showing the invention.

FIG. 2 is a schematic illustration showing a structure of the invention.

FIG. 3 is a schematic illustration showing a windward side of the invention contacting with the flowing air streams.

FIG. 4 is a structural schematic illustration showing the invention applied to a LED road lamp.

### DETAILED DESCRIPTION OF THE INVENTION

The present invention will be apparent from the following detailed description, which proceeds with reference to the accompanying drawings, wherein the same references relate to the same elements.

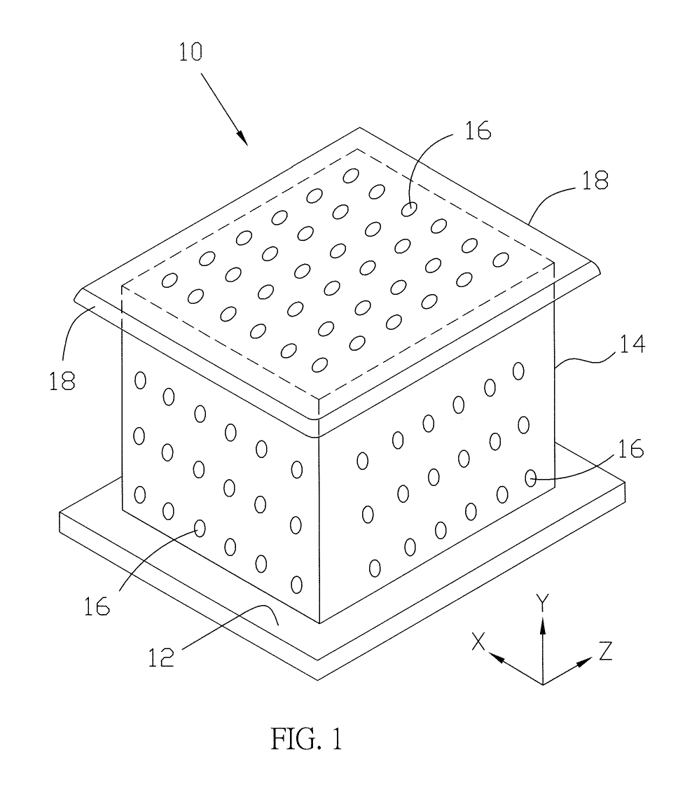

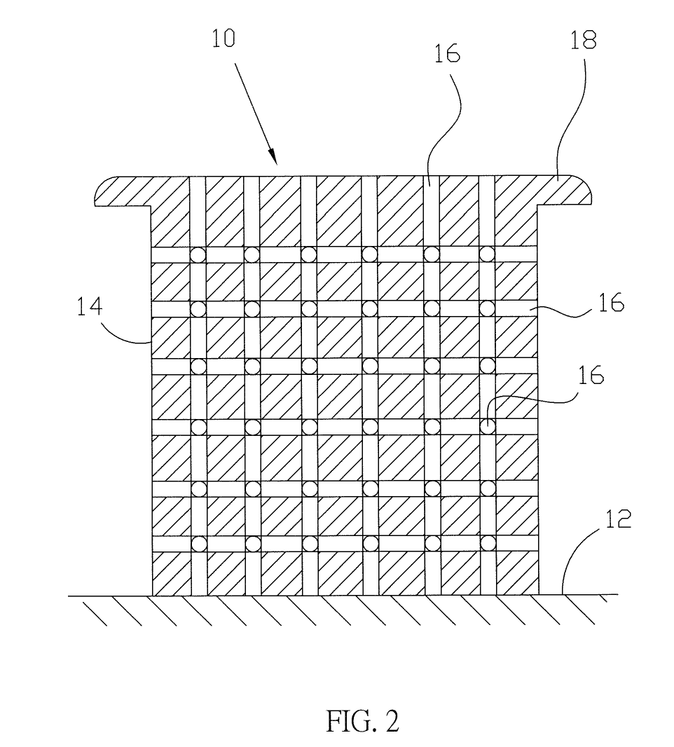

Referring to FIGS. 1 and 2, a heat sink 10 includes a base 12 and a polygonal heat dissipating module 14 disposed on the base 12. The base 12 and the polygonal heat dissipating module 14 are integrally formed with each other.

Also, heat dissipating channels 16 penetrate through the polygonal heat dissipating module 14. More specifically, the heat dissipating channels 16 can be arranged in different directions of the polygonal heat dissipating module 14. For example, a part of the heat dissipating channels 16 penetrate through the polygonal heat dissipating module 14 in the X-axis direction, another part of the heat dissipating channels 16 penetrate through the polygonal heat dissipating module 14 in the Y-axis direction, and still another part of the heat dissipating channels 16 penetrate through the polygonal heat dissipating module 14 in the Z-axis direction.

The heat dissipating channels 16 on the heat dissipating module 14 can be distributed in the X-axis and Y-axis directions, or X-axis, Y-axis and Z-axis directions, and the channels in the directions may communicate with one another.

Furthermore, a flange 18 is formed on an end portion of the polygonal heat dissipating module 14. As shown in the drawing, the flange 18 is disposed on the Y-axis-direction end portion of the polygonal heat dissipating module 14, and the flange 18 projects beyond a lateral side surface of the polygonal heat dissipating module 14.

As shown in FIG. 2, the base 12 and the polygonal heat dissipating module 14 are integrally formed, so the heat on the base 12 can be conducted to the polygonal heat dissipating module 14.

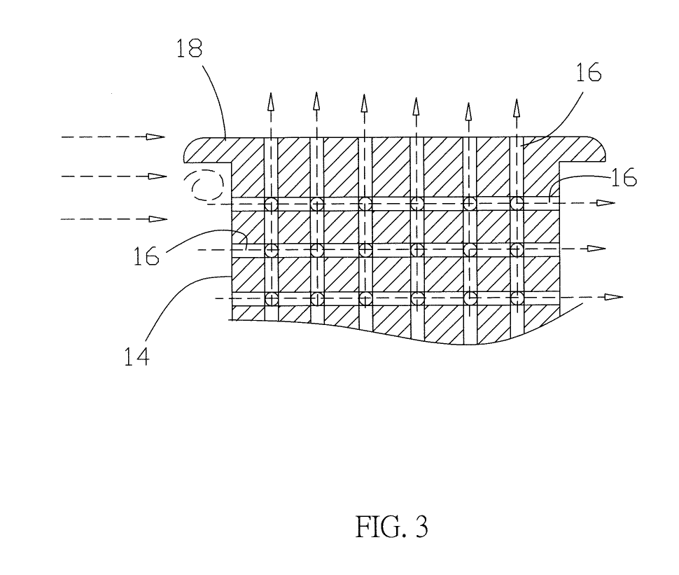

As shown in FIG. 3, when the flowing air streams contact with the polygonal heat dissipating module 14, the flowing air streams can enter the polygonal heat dissipating module 14 from the corresponding heat dissipating channels 16. Because the heat dissipating channels 16 are distributed in various directions and communicate with one another, the air streams can flow through and out of the heat dissipating channels 16 in various directions. Consequently, the air streams can flow deeply inside the polygonal heat dissipating module 14 and bring out the heat. Thus, the invention can obtain the higher heat dissipation efficiency.

Next, the heat dissipating channels 16 of the invention are arranged in multiple directions. So, no matter which direction the air steams flow, their moving directions or component directions can correspond to the heat dissipating channels 16, and the air streams can smoothly flow through the heat dissipating channels 16. Thus, the invention has the good heat dissipating effect, and the assembling direction of the polygonal heat dissipating module 14 has nothing to do with the flowing directions of the air streams, so that the heat dissipating module 14 can be simply and conveniently assembled.

In addition, the polygonal heat dissipating module 14 of the invention has the flange 18, so that the maelstrom effect can be formed between the flange 18 and the lateral side surface of the polygonal heat dissipating module 14 when the flowing air streams contact with the polygonal heat dissipating module 14. Thus, the flowing air streams can be smoothly and quickly guided into the heat dissipating channels 16 near the end portion. Meanwhile, the possibility that the flowing air streams contact with the flange 18 and the lateral side surface of the polygonal heat dissipating module 14 is increased so that the heat dissipating effect is enhanced.

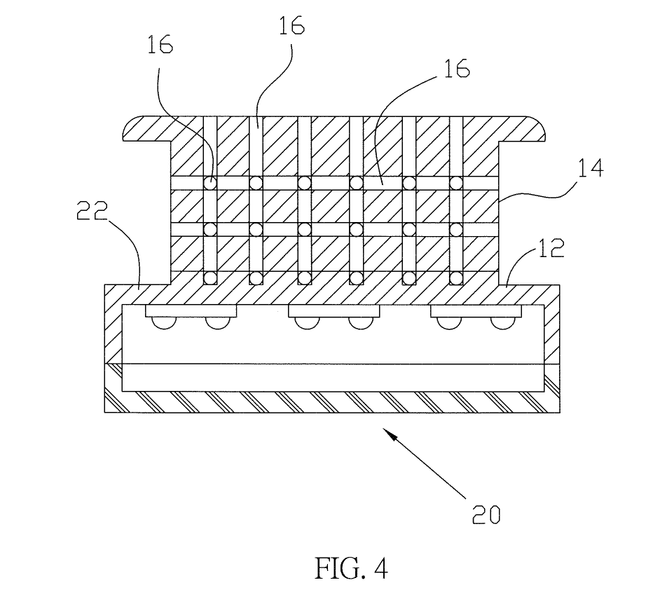

As shown in FIG. 4, the invention can be applied to a LED road lamp 20. More specifically, the base 12 may be an upper lamp shell 22 of the LED road lamp 20, while the polygonal heat dissipating module 14 is a heat dissipating member of the LED road lamp 20. The structural configurations of the polygonal heat dissipating module 14 and the heat dissipating channels 16 of the invention can make the air streams, flowing in different directions, enter the heat dissipating channels 16, can disperse the air streams and can let the dispersed air streams flow out of the heat dissipating channels 16. Thus, the working temperature of the LED road lamp 20 can be quickly decreased.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A heat sink, comprising:
a base;
a polygonal heat dissipating module disposed on and integrally formed with the base; and
heat dissipating channels, which penetrate through the polygonal heat dissipating module and are arranged in different directions.

2. The heat sink according to claim 1, further comprising a flange, which is formed on an end portion of the polygonal heat dissipating module and projects beyond a lateral side surface of the polygonal heat dissipating module.

3. The heat sink according to claim 1, wherein the heat dissipating channels are arranged in two directions orthogonal to each other.

4. The heat sink according to claim 1, wherein the heat dissipating channels are arranged in three directions orthogonal to one another.

5. The heat sink according to claim 1, wherein the base is an upper lamp shell of a LED road lamp.
